(19) United States
(12) Patent Application Publication
(10) Pub. No.: US 2004/0073820 A1
(43) Pub. Date: Apr. 15, 2004

(54) Charging device with output interface of universal serial bus

(75) Inventor: Ying-Hao Hsu, Kaohsiung (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ CORPORATION

(21) Appl. No.: 10/678,429

(22) Filed: Oct. 3, 2003

(30) Foreign Application Priority Data
Oct. 14, 2002 (TW) 91123567

(51) Int. Cl. G06F 1/26

(52) U.S. Cl. 713/300

(57) ABSTRACT

A charging device with a USB interface. The AC power adapter receives external AC power. The car lighter adapter receives external DC power provided by a DC power output terminal of a car. The battery pack receives another external DC power provided by batteries. The voltage converter with an AC-to-DC converter and a DC power converter converts external AC power and external DC power received by the car lighter adapter and the battery pack to DC power having a predetermined voltage level. The USB output terminal outputs DC power.

### BACKGROUND OF THE INVENTION

1. Field of the Invention

The present invention relates in general to a charging device. In particular, the present invention relates to a charging device having a Universal Serial Bus (USB) output interface and a plurality of types of power connectors.

2. Description of the Related Art

Developed in 1996, USB is widely used and accepted as a standard for the new generation of serial ports because of its high data transmission rate (12M bits/sec), error prevention, high expandability, low cost, and plug-and-play functionality. A wide variety of computer peripherals support the USB interface, for example, monitors, keyboards, mouse pointing devices, joysticks, scanners, and printers.

In addition, with the wide use of personal and notebook computers, many portable products also support the USB interface to operate with personal or notebook computers, for example, watches, lamps, personal digital assistant (PDA) and digital cameras. In addition, portable products also use or are charged by notebook provided power. Thus, the dependency between portable products and personal and notebook computers has increased.

The power supply used by a portable product is very important. Thus, a portable product must have a power connector for receiving external power to supply operation or charge its battery. However, power connectors cause portable products to have larger size and higher price. Since the USB interface exists in portable products and is capable receiving power, it is advantageous to combine the power connector and the USB interface in one module. As shown in FIG. 1, the portable product 10 receives power from the host computer 12 through the USB interface 14.

However, portable products using USB interface must be operated with the host computer to receive power or charge. Thus, it is inconvenient for a user to carry the portable product.

### SUMMARY OF THE INVENTION

The object of the present invention is thus to provide a charging device with a USB interface for directly providing power to a portable product having a USB interface without utilizing a host computer. Thus, the concern about a power supply for the portable product is solved.

To achieve the above-mentioned object, the present invention provides a charging device with a USB interface. The AC power adapter receives external AC power. The car lighter adapter receives external DC power provided by a DC power output terminal of a car. The battery pack receives an additional external DC power output from a battery. The voltage converter having an AC-to-DC converter and a DC power converter converts the external AC power and the external DC power received by the car lighter adapter and the battery pack to a DC power having a predetermined voltage level. The USB output terminal outputs the DC power.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 shows a schematic view of the portable products connected to a host computer through a USB connector.

FIG. 2 shows a block diagram of the charging device with USB interface according to the first embodiment of the present invention.

FIG. 3 shows a circuit of the AC-to-DC converter 221.

FIG. 4 shows a circuit of the DC converter 222.

FIGS. 5A-5D show schematic views of the charging device according to the first embodiment of the present invention.

FIGS. 6A and 6B show schematic views of the charging device according to the first embodiment of the present invention.

FIGS. 7A and 7B show schematic views of the charging device according to the first embodiment of the present invention.

FIG. 8 shows another block diagram of the charging device with USB interface according to the second embodiment of the present invention.

FIG. 9 shows a schematic view of the charging device according to the second embodiment of the present invention.

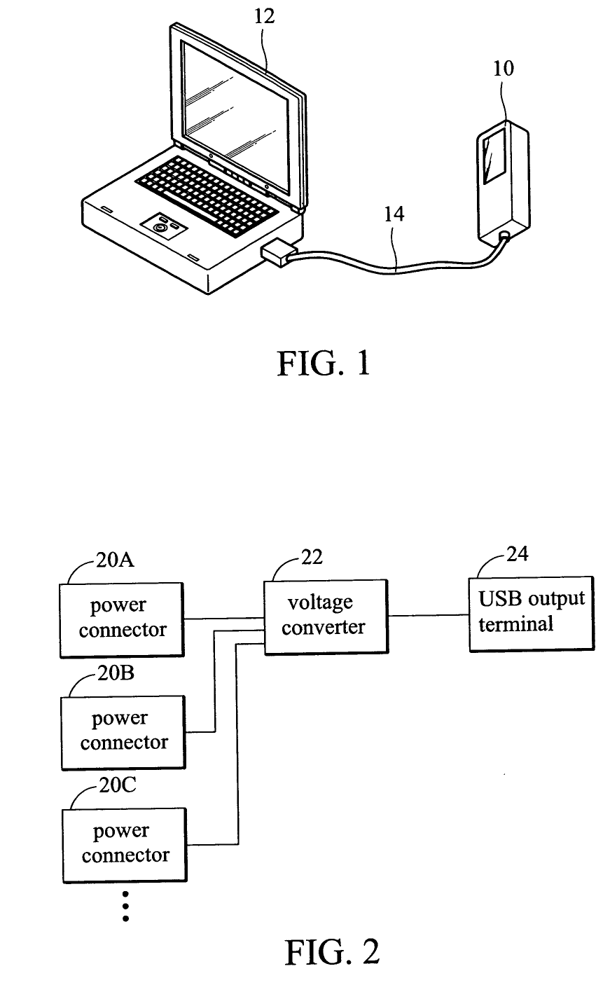

### DETAILED DESCRIPTION OF THE INVENTION

### First Embodiment

FIG. 2 shows a block diagram of the charging device with USB interface according to the first embodiment of the present invention. The charging device with USB interface according to the embodiment of the present invention comprises a plurality of power connectors 20A, 20B and 20C, the voltage converter 22, and the USB output terminal 24. The power connector receives the voltage provided from external power source. In order to conveniently receive power, the power connector can be an adapter for connecting an AC power source, the car lighter adapter, and the battery pack. The circuit of the voltage converter 22 depends on the received power type from the power connector. If the voltage received by the power connector is AC power, the voltage converter 22 is thus an AC-to-DC converter to convert the received AC power to the DC power conforming to the USB standard (5V, 0.5 A). If the voltage received by the power connector is DC power, the voltage converter 22 is thus a DC converter to convent the received DC power to DC power conforming to the USB standard (5V, 0.5 A). In addition, if the power connectors respectively receive DC power and AC power, they are then connected to the AC-to-DC converter 221 and DC converter 222, respectively.

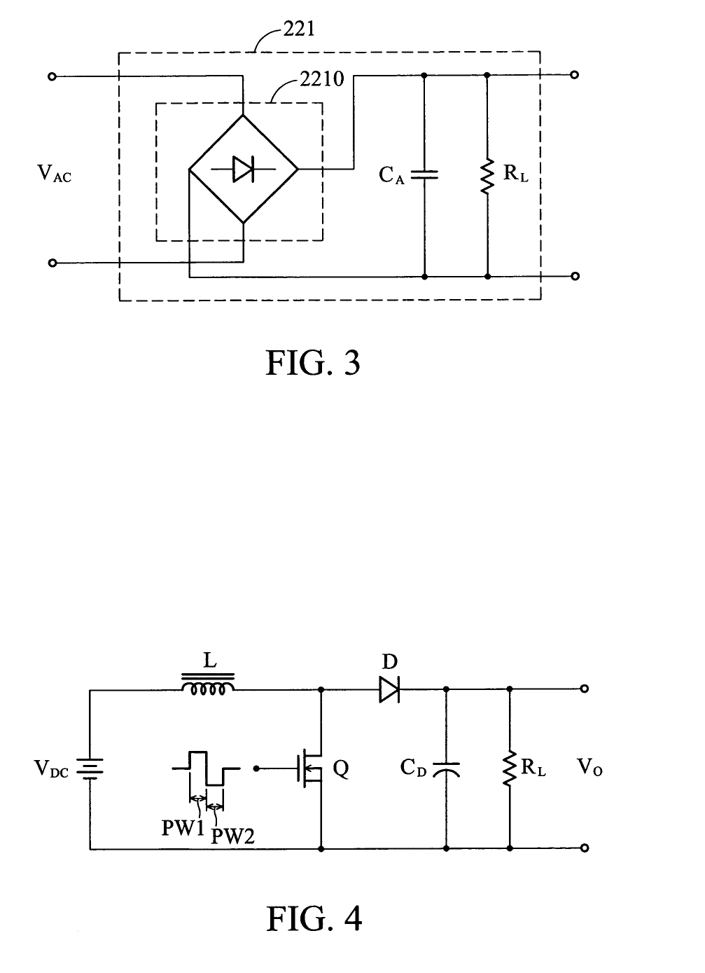

FIG. 3 shows a circuit of the AC-to-DC converter 221. The AC power V_{AC} received by the power connector is rectified by the Bridge rectifier 2210 to AC power, and then charges the capacitor CA. Finally, the DC power difference conforming to the USB standard (5V, 0.5 A) is generated between both terminals of the loading resistor R_{L}.

FIG. 4 shows a circuit of the DC converter 222. Assuming the capacitor C_{D} has been charged, the energy generated by the DC power received by the power connector is stored in the inductor L when the power-switching element Q is turned on. At this time, the voltage level of the anode of the diode D is lower than output voltage V_{O}. Thus, the diode D is inverse biased, so the charge stored in the capacitor C_{D} generates a current flowing through the loading resistor R_{L}. When the power-switching element Q is turned off, the DC power received by the power connector keeps flowing through the inductor L. However, the polarity of the inductor L is inverted and makes the diode D forward biased. Thus, another current is generated by the energy stored in the inductor L and flows through the loading resistor R_{L}. Finally, the DC power difference conforming to the USB standard (5V, 0.5 A) is generated between both terminals of the loading resistor R_{L}. Here, the power-switching element Q is switched by the input pulses, and the voltage difference is changed by adjusting the duty of the input pulse.

Finally, the voltage output by the voltage converter 22 is provided to the USB interface of the portable product through the USB output terminal 24 for operation or charging. According to the embodiment of the present invention, the housings of the USB output terminal 24 comprise male and female configurations. Thus, the charging device according to the embodiment of the present invention has extensive compatibility.

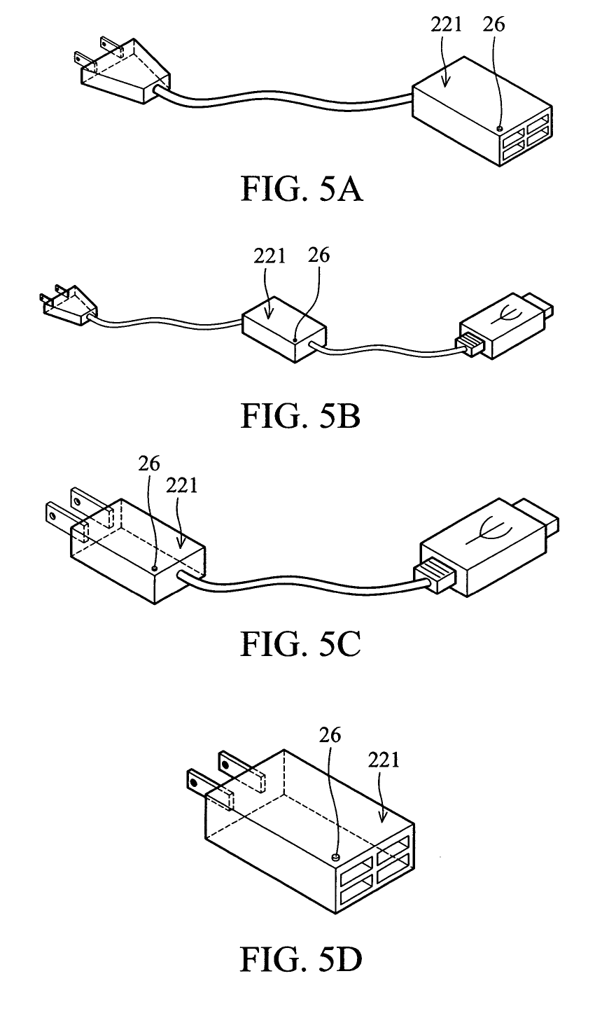

FIGS. 5A-5D show schematic views of the charging device according to the first embodiment of the present invention. The power connector of each charging device shown in FIGS. 5A-5D is an AC power adapter for receiving external AC power. The reference number 221 represents the position of the AC-to-DC converter. The USB connectors shown in FIGS. 5A and 5D are female configurations, and the USB connectors shown in FIGS. 5B and 5C are male configurations. In addition, the charging device according to the present embodiment further comprises a power supply indicator 26, which is an LED, to indicate if the power supply or charger is available.

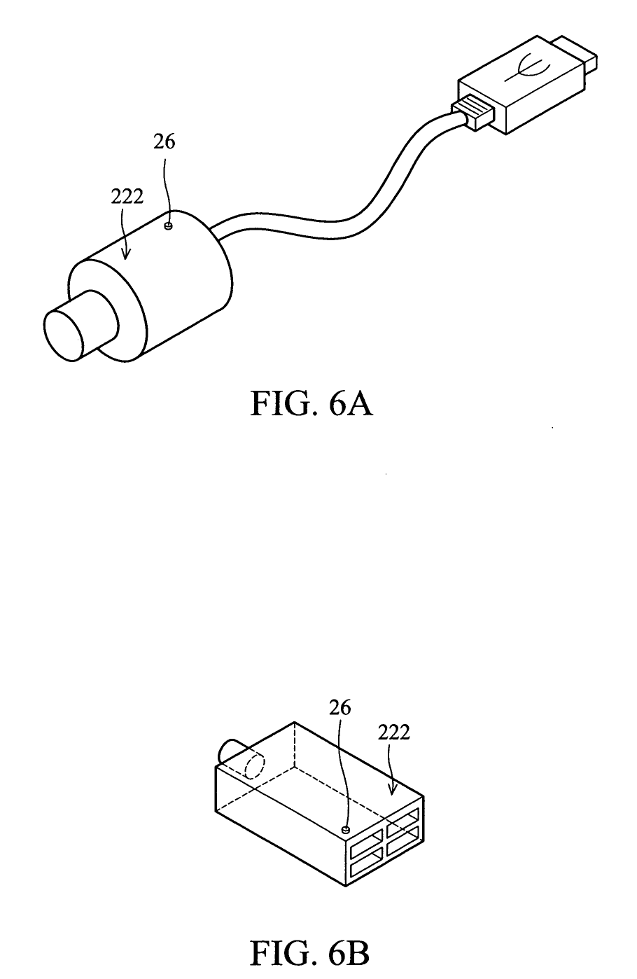

FIGS. 6A and 6B show schematic views of the charging device according to the first embodiment of the present invention. The power connector of each charging device shown in FIGS. 6A and 6B is the car lighter adapter for receiving external DC power. The reference number 222 represents the position of the DC converter. The USB connector shown in FIG. 6A is male configuration and the USB connector shown in FIG. 6B is female configuration. In addition, the charging device according to the present embodiment further comprises a power supply indicator 26, which is an LED, to indicate if the power supply or charger is available.

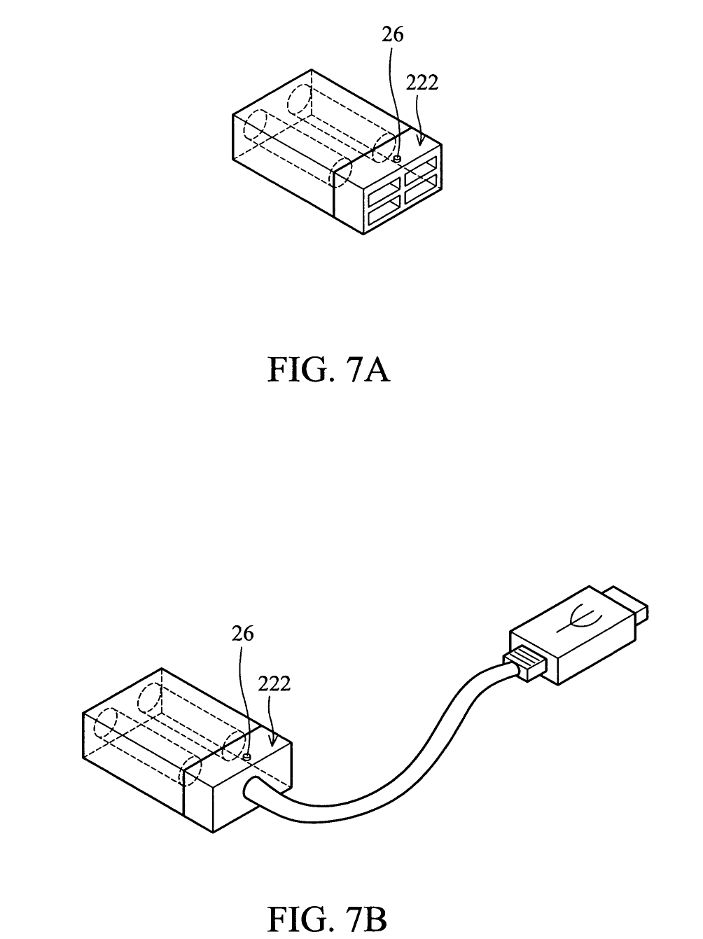

FIGS. 7A and 7B show schematic views of the charging device according to the embodiment of the present invention. The power connector of each charging device shown in FIGS. 7A and 7B is a battery pack for receiving the external DC power provided by batteries. The reference number 222 represents the position of the DC converter. The USB connector shown in FIG. 7A is a female configuration and the USB connector shown in FIG. 7B is a male configuration. In addition, the charging device according to the present embodiment further comprises a power supply indicator 26, which is an LED, to indicate if the power supply or charger is available. The advantage of using the battery pack as the power source is that the battery is easily acquired.

### Second Embodiment

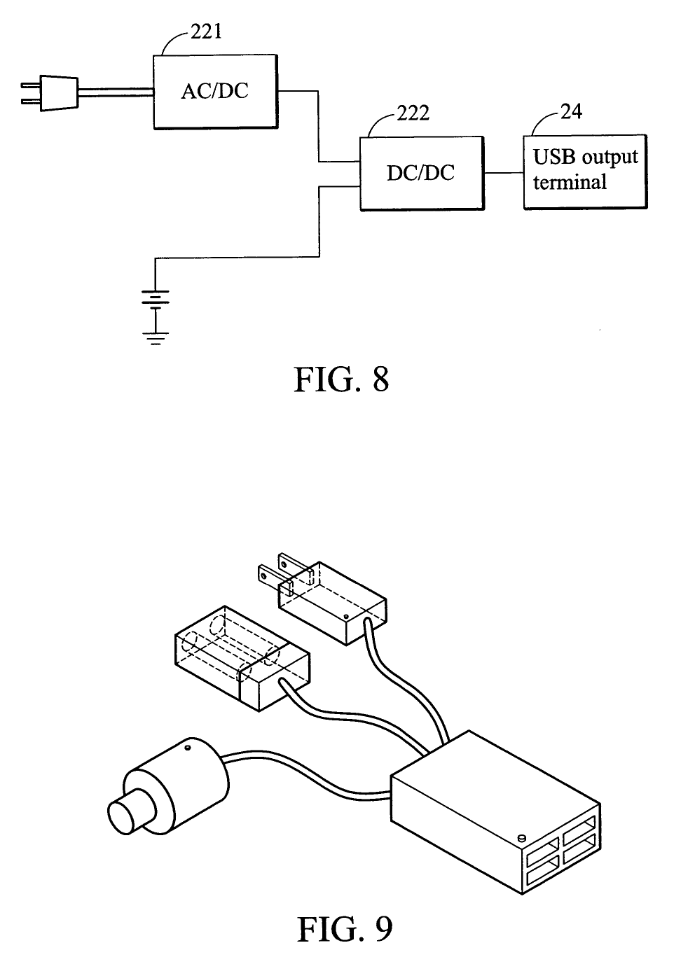

FIG. 8 shows another block diagram of the charging device with USB interface according to the second embodiment of the present invention. When the power connector receives AC power, the AC-to-DC converter 221 converts the received AC power to the DC power in advance, the DC converter 222 then converts the generated DC power to another DC power conforming to the USB standard (5V, 0.5 A) and output from the USB output terminal.

FIG. 9 shows a schematic view of the charging device according to the second embodiment of the present invention. The power connectors of the charging device shown in FIG. 9 are an AC power adapter, a car lighter adapter, and a battery pack. Thus, the user selects an applicable type of the power connector according to the available power source to be received. For example, the user can still use a battery to charge the portable when no external AC or DC power provided by the car lighter adapter. The user can provide a battery for charging the portable product. In addition, the different types of power connectors are detachable with an adapter connector. Thus, the user can select an appropriate power connector attachment to receive external power without carrying all the power connectors.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A charging device with a USB interface, comprising:
a plurality of power connectors for receiving external power;
a voltage converter for converting the external power to the DC power having a predetermined voltage level; and
a USB output terminal for outputting the DC power.

2. The charging device as claimed in claim 1, wherein the power connector is an AC power adapter for receiving the external power.

3. The charging device as claimed in claim 2, wherein the voltage converter comprises an AC-to-DC converter for converting the external power to the DC power having the predetermined voltage level.

4. The charging device as claimed in claim 1, wherein the power connector is a battery pack for receiving external DC power provided by batteries.

5. The charging device as claimed in claim 4, wherein the voltage converter comprises a DC converter for converting the external DC power to the DC power having the predetermined voltage level.

6. The charging device as claimed in claim 1, wherein the power connector is a car lighter adapter for receiving external DC power provided by a DC power output terminal of a car.

7. The charging device as claimed in claim 6, wherein the voltage converter comprises a DC converter for converting the external DC power to the DC power having the predetermined voltage level.

8. The charging device as claimed in claim 1, wherein the predetermined voltage level is about 5V.

9. The charging device as claimed in claim 1, wherein the structure of the USB output terminal is a female configuration.

10. The charging device as claimed in claim 1, wherein the structure of the USB output terminal is a male configuration.

11. A charging device with a USB interface, comprising:
a battery pack for receiving external DC power;
a voltage converter having a DC converter for converting the external power to DC power having a predetermined voltage level; and
a USB output terminal for outputting the DC power.

12. The charging device as claimed in claim 11, further comprising an AC power adapter for receiving external AC power.

13. The charging device as claimed in claim 12, wherein the voltage converter further comprises an AC-to-DC converter for converting the external AC power to the DC power having the predetermined voltage level.

14. A charging device with a USB interface, comprising:
an AC power adapter for receiving external power;
a voltage converter having an AC-to-DC converter for converting the external power to DC power having a predetermined voltage level; and
a USB output terminal for outputting DC power.

15. A charging device with a USB interface, comprising:
an AC power adapter for receiving external AC power;
a car lighter adapter for receiving external DC power provided by a DC power output terminal of a car;
a battery pack for receiving another external DC power provided by batteries;
a voltage converter having an AC-to-DC converter and a DC power converter for converting the external AC power and the external DC power received by the car lighter adapter and the battery pack to DC power having a predetermined voltage level; and
a USB output terminal for outputting the DC power.

16. The charging device as claimed in claim 15, further comprising an adapter connector for selectively connecting with one of the AC power adapters, the car lighter adapter, and the battery pack.

17. The charging device as claimed in claim 15, wherein the predetermined voltage level is about 5V.

18. The charging device as claimed in claim 15, wherein the structure of the USB output terminal is a female configuration.

19. The charging device as claimed in claim 15, wherein the structure of the USB output terminal is a male configuration.
